(19) United States
(12) Patent Application Publication
(10) Pub. No.: US 2006/0154378 A1
(43) Pub. Date: Jul. 13, 2006

(54) Method for measuring the leaching of encapsulated material into application media

(76) Inventors: Yabin Lei, Holmdel, NJ (US); Lewis Michael Popplewell, Morganville, NJ (US); Kaiping Lee, Morganville, NJ (US); Theodore James Anastasiou, Red Bank, NJ (US)

Correspondence Address: INTERNATIONAL FLAVORS & FRAGRANCES INC., 521 WEST 57TH ST, NEW YORK, NY, 10019, US

(21) Appl. No.: 11/034,593

(22) Filed: Jan. 13, 2005

(51) Int. Cl. G01N 1/10

(52) U.S. Cl. 436/178

(57) ABSTRACT

The invention provides a facile method for measuring the leaching of encapsulated active ingredient from application media. This is achieved by separating a container by a membrane permeable to encapsulated material, but not to capsules; pouring a solution of the application medium into a first part of the container; pouring a solution of the application medium and encapsulated active ingredient into a second part of the container; allowing the solutions in both parts of the container to reach equilibrium; and measuring the concentration of the active ingredient in the first part of the container by directly injecting the solution into a Gas Chromatograph or High Performance Liquid Chromatograph.

### FIELD OF THE INVENTION

The invention relates to the separation and measurement of the rate of release of encapsulated material from microcapsule in application media, such as a detergent or fabric softener.

### BACKGROUND OF THE INVENTION

Microencapsulation is a widely used delivery method for delivering active ingredients into the various systems. There are two main types of systems known for the encapsulation of active ingredients. One is a matrix system, in which the active ingredient is dispersed in the matrix made of a polymeric material. Another system uses a core/shell structure that contains an active ingredient. One of the primary objectives of using microencapsulation is the controlled release of encapsulated ingredient in targeted application.

The present invention uses dialysis or filtration to separate the active ingredient molecules from the capsules. Dialysis is an established method that has been used in clinical and academic research for several decades. During conventional dialysis, the sample is separated from the medium with a semi-impermeable membrane in a dialysis cell or bag. The sample to be dialyzed is not in direct contact with the medium. Many biological samples can be purified this way prior to their analysis. Separation of molecules in a solution using a membrane is disclosed in U.S. Pat. No. 5,077,217.

In order to measure the release rate of encapsulated ingredient in an application medium, one needs to measure either the amount of the ingredient leached out into the application medium or the amount of ingredient remaining in the capsule. Direct sampling is difficult because of the complex composition of the application medium and the polymeric materials used in the preparation of the matrix or capsule. Often direct analysis is not feasible because of interference from the application media. Current analytic methodology involves the solvent extraction of the active ingredient from the medium, which usually contains the capsule, and quantification of materials by a suitable analytic method such as gas chromatograph (GC), High Performance Liquid Chromatograph (HPLC) or other suitable analytical techniques. There are several disadvantages with this approach. Solvent extraction is time consuming and, in general, the efficiency is less than 100%. Furthermore, any indigenous surface active material can make the extraction process extremely difficult, because some organic solvents normally used during this procedure are emulsified in the process. Thus, a new extraction procedure has to be developed for each different application medium.

Another indirect method traditionally used in the analysis of fragrance is the headspace (HS) method. In this method, a calibration curve is first obtained according to Henry's law for the various application medium. The amount of fragrance in the application medium is then inferred by measuring the gas phase or head space concentration of the ingredient by GC. This method can be quite laborious because the calibration curve is medium dependent and not transferable. Extensive calibration has to be performed if the analytic results are desired in a matrix of medium for product and process optimization.

Furthermore, the direct injection of mixtures containing fragrance chemicals and application medium as detergent base has not been reported before due the complexity of the system. Accordingly, a direct and facile analytical method must be developed for the rapid measurement of the concentration of leached chemicals in an application environment.

### SUMMARY OF THE INVENTION

The present invention provides a facile method for measuring the leaching of encapsulated active ingredient from capsules into application media. The active ingredient can be a fragrance chemical, mixture of fragrance chemicals or any other analyte encapsulated in the capsule core. This is achieved by separating a container by a membrane permeable to encapsulated material, but not to capsules; pouring a solution of the application medium in the first part of the container; pouring a solution mixture of the application medium and encapsulated active ingredient into a second part of the container; allowing the solutions in both parts of the container to reach equilibrium; and measuring the concentration of the active ingredient in the first part of the container by directly injecting the solution into GC or HPLC.

In one embodiment of the invention, a method for measurement of release rate of encapsulated material comprising the following steps: providing a container; providing a semi-permeable membrane within said container, thereby dividing said container into a first and second part, said membrane being permeable to encapsulated active ingredient, but not permeable to capsules; providing a solution of application medium in the first part of the container; providing a solution of application medium and encapsulated active ingredient in the second part of the container; allowing the first and the second part to be held in equilibrium for at least one hour; and measuring the concentration of the active ingredient in the first part of the container.

In another embodiment of the invention, a method for measurement of the release rate of encapsulated component comprising the following steps: providing a filtration apparatus, providing a filter; providing a solution mixture of application medium and encapsulated active ingredient which was stored at room temperature or elevated temperature for the desired period of time filtering the solution mixture through the selected filter; measuring the concentration of the active ingredient in the filtrate.

In a further embodiment of the invention, the dialysis and direct injection method can also be used to determine the relative binding affinity or binding constant of different application media for fragrance ingredient comprising the following steps: providing a container; providing a semi-permeable membrane within said container, thereby dividing said container into a first and second part, said membrane being permeable to the active ingredient, but not permeable to application medium; providing a solution of application medium in the first part of the container; providing a solution of a different application medium and active ingredient in the second part of the container; allowing the first and the second part to be held in equilibrium for at least one hour; and measuring the concentration of the active ingredient in the first part of the container.

In yet another embodiment of the present invention, the dialysis and direct injection method is also used to determine the rate of equilibration and translocation of fragrance ingredient in application medium comprising the following steps: providing a container; providing a semi-permeable membrane within said container, thereby dividing said container into a first and second part, said membrane being permeable to the active ingredient; providing a solution of application medium in the first part of the container; providing a solution of the same application medium and active ingredient in the second part of the container; allowing the first and the second part to be held in equilibrium for at least one hour; and measuring the concentration of the active ingredient in the first part of the container.

These and other embodiments of the present invention will be apparent by reading the following specification and claims.

### BRIEF DESCRIPTION OF THE DRAWING

FIG. 1 illustrates a dialysis cell setup of the present invention.

### DETAILED DESCRIPTION OF THE INVENTION

The present invention is an analytical method that allows the facile measurement of the release profile of entrapped materials into an application medium. In a preferred embodiment, the present invention concerns the measurement of leached fragrance molecule in a surfactant environment. The invention is based on the innovative use the principle of chemical equilibrium and equilibrium dialysis in a novel configuration. The particular configuration is adaptable to many unique applications.

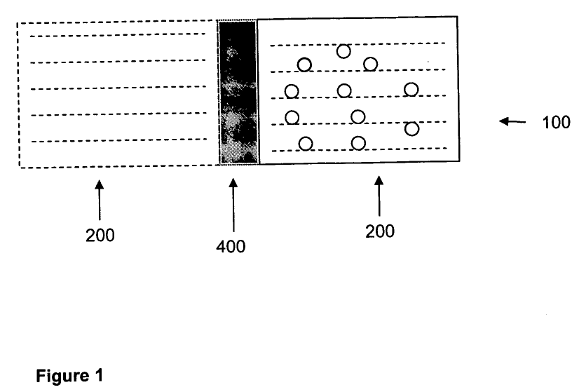

In the present invention, the sample is allowed to make direct contact with the medium. In FIG. 1, the invention is illustrated with an experimental setup using a dialysis cell (100). The application medium such as surfactant solution is contained in one side (200) of the dialysis cell (100). Contained in the other half-cell (300) is a solution prepared from the application medium and the active ingredient, fragrance or, in our case, fragrance-containing microcapsules. A semi-impermeable membrane (400) is employed to separate the half cells. Employed this way, several unique features of the invention are materialized and they are described below.

The membrane (400) acts as a barrier that permits the movement of fragrance molecule, but not polymer capsules. The leached out fragrance molecules can freely translocate across the membrane and are equally distributed in the two compartments at equilibrium. This is made possible because the medium is the same in both sides. This is not the case in a conventional dialysis setup. The concentration of leached out fragrance molecule is directly measured with any suitable analytical technique known to a person skilled in the art. The suitable analytical techniques include but not limited to gas chromatography (GC), High Performance Liquid Chromatography (HPLC), Nuclear Magnetic Resonance spectroscopy (NMR) and Infrared spectroscopy (IR). This allows the direct quantification of the analyte. There is no time consuming solvent extraction involved.

The membrane (400) of the present invention is selected from a wide variety of materials including without limitation, regenerated cellulose, cellulose acetate, cellulose nitrate, mixed cellulose esters, polyvinylidene difluoride, polysulfone (PES), polyamide, nylon, polycarbonate, polytetrafluoroethylene (Teflon), polypropylene, glass microfiber, Thin Film composite membrane such as those made by Dow Chemical, and MicroPES, which is a sulfonated polyethersulfone made by Industrial Membrane. Choice of a particular membrane depends on analyte properties. The pore size of the membrane is in the range of about 20 nanometers to about 20 microns, preferably less than about 1 microns. Molecular weight cutoff (MWCO) of the polymer membrane is in the range of about 100 Dalton to about 1 million Dalton, preferably from about 100 Dalton to about 5000 Dalton, most preferably from about 100 Dalton to about 250 Dalton. The thickness of the polymer membrane is in the range of about 1 micron to about 1000 micron.

Although much of the description of the present invention has been directed to fragrance chemicals and fragrancing consumer products, the present invention is also advantageously used with encapsulated flavors as well. Those with skill in the art appreciate that oral care products such as toothpaste, gels, mouthwashes, mouth rinses, chewing gums and mouth sprays, as well as foodstuffs and beverages can also employ encapsulated flavor ingredients. It is well appreciated by those with skill in the art that food grade materials are employed in the practice of the invention with encapsulated flavors. As used herein foodstuff is understood to mean The term “foodstuff” as used herein includes both solid and liquid ingestible materials for man or animals, which materials usually do, but need not, have nutritional value. Thus, foodstuffs include food products, such as, meats, gravies, soups, convenience foods, malt, alcoholic and other beverages, milk and dairy products, seafood, including fish, crustaceans, mollusks and the like, candies, vegetables, cereals, soft drinks, snacks, chewing gum, dog and cat foods, other veterinary products and the like.

One feature of the invention is that it allows the rapid quantification of the interaction of the medium with microcapsules by measuring the amount of released materials as the results of the direct contact between medium and microcapsule and the interaction between them when they are in direct contact. This is not possible in the conventional dialysis setup.

Another particular advantage of the invention is that it allows the measurement of fragrance molecules that have very low vapor pressure. Current analytical techniques such as SPME and headspace techniques cannot accurately measure the concentration of materials in surfactant solution that have very lower vapor pressure. The direct injection method completely eliminates this problem.

There are particular advantages when the invention is applied to a surfactant solution with the concentration of surfactant being at least 1%, preferably more than 5 and most preferably greater than about 9 weight percent of the solution. Due to the high level of surfactant present in these solutions, the solvent extraction of fragrance molecules, or organic molecules, from the surfactant solution is a tedious and inefficient process. This is caused by the fact that most of the solvent used for extraction gets emulsified when in contact with a surfactant solution. Because of the strong absorption of fragrance by surfactants, the vapor phase concentration fragrance component can decrease significantly. This can make any indirect analytical method far less accurate and less desirable.

In another application of the invention, the release of the fragrance from the polymer capsule is measured. This is accomplished by the following steps: providing a container; providing a semi-permeable membrane within said container, thereby dividing said container into a first and second part, said membrane being permeable to encapsulated active ingredient, but not permeable to polymer particles; providing a solution of application medium in the first part of the container; providing a solution of application medium and fragrance loaded particles in the second part of the container; allowing the first and the second part to be held in equilibrium for at least one hour; and measuring the concentration of the active ingredient in the first part of the container.

In another application of the invention, the dialysis and direct injection method is also used to determine the relative binding affinity or binding constant of the different application media for an active ingredient. This is accomplished as follows. The first compartment of the dialysis cell is filled with an active ingredient solution of known concentration in application medium A and the second compartment of the dialysis cell is filled with application medium B. The analyte concentration in medium B is determined by direct injection as a function of time. If the binding affinity of media A and B is the same for the particular analyte, the equilibrium concentration of the active ingredient will be the same. If the concentration of the analyte is different in the two application media, the binding constants for the active ingredient is different in the two different media. The difference is used in calculating the relative biding affinity. If one follows the increase of concentration of the analyte in medium B as a function of time, the time-dependent diffusion behavior of the analyte is determined. These unique features may be used by those skilled in art to screen application media for optimal product stability.

The dialysis and direct injection method is also used to determine the rate of equilibration and translocation of fragrance ingredient in application medium. This is accomplished as follows. The first compartment of the dialysis cell is filled with an active ingredient solution of known concentration in application medium A and the second compartment of the dialysis cell is filled with the same application medium. The increase in analyte concentration in the second compartment is determined directly by direct injection at given time interval. Equilibration is established when there is no further change in analyte concentration in the second compartment. This rate constant can be used to estimate the binding affinity of active ingredient by application medium because the active ingredient has to be released from active-containing vesicles to be absorbed by vesicles that does not have any active ingredient at time zero. When different membrane material is used, the dialysis and direct injection method is used to measure the relative permeability of active ingredient across membranes. These unique features may be used by those skilled in art to screen application media for optimal product stability.

The dialysis and direct injection is also used as follows. The capsule slurry is blended in the application medium at the desired concentration. The sample is stored in an oven at the desired temperature for the duration of the storage test. Stirring can be provided if needed. A portion of the sample is then transferred into a dialysis cell or bag. The aged sample is placed into the first compartment of the dialysis cell. The second compartment of the dialysis cell is filled with the application medium. The system is allowed to equilibrate for the desired period of time. The amount of the active ingredient leached out is then quantified by injecting a small amount of sample taken out from the second compartment into GC or HPLC column and analyzed accordingly. This allows the sample to be made in bulk and then evaluated using the inventive technique at any stage desired. The dialysis time may be adjusted as desired, but will generally be shorter than the storage time.

When the invention is used in this particular configuration, a filtration step can also be used to remove the capsule from the aged sample. In the latter case, the filtrate is then transferred directly into a GC or HPLC column for direct analysis. The applicability of the filtration removal depends on the Theological and chemical property of the samples. Filtration is facilitated when there is minimal pressure drop, therefore, proper filter selection is also critical.

The physical property of the filter that is used in the above procedure is best characterized by their pore size. Selection of the appropriate pore size is dependent on the physical dimension of the particle size, the loading of particles, as well as the particle morphology and character. Also, the characteristics and composition of the application base are critical. The pore size can vary from 0.2 μm to 10 μm. The preferred filtration medium is made of cellulose acetate and glass fiber. Commercial filtration papers, membranes and devices such as those manufactured by Millipore or Whatman may be used or adapted for this application. The membrane filter can also be selected from a wide variety of materials including without limitation, regenerated cellulose, cellulose acetate, cellulose nitrate, mixed cellulose esters, polyvinylidene difluoride, polysulfone (PES), polyamide, nylon, polycarbonate, polytetrafluoroethylene (Teflon), polypropylene, glass microfiber, Thin Film composite membrane such as those made by Dow Chemical, and MicroPES, which is a sulfonated polyethersulfone made by Industrial Membrane. Choice of a particular membrane depends on analyte properties. The pore size of the membrane is in the range of about 20 nanometers to about 20 microns, preferably less than about 1 microns. The thickness of the polymer membrane is in the range of about 1 micron to about 1000 micron.

The capsule system of the present invention is not critical. Suitable capsule materials include substituted or un-substituted acrylic acid co-polymer, preferably a substituted or un-substituted acrylamide-acrylic acid co-polymer cross-linked with a melamine-formaldehyde pre-condensate and/or a urea-formaldehyde pre-condensate; and/or a substituted or un-substituted C₁-C₄ alkyl acrylate-acrylic acid co-polymer cross-linked with a melamine-formaldehyde pre-condensate and/or a urea-formaldehyde pre-condensate; and/or a methacrylic acid-acrylic acid co-polymer cross-linked with a melamine-formaldehyde pre-condensate and/or a urea-formaldehyde pre-condensate and/or a substituted or un-substituted C₁-C₄ alkyl acrylate-acrylic acid-acrylamide co-polymer cross-linked with a melamine-formaldehyde pre-condensate and/or a urea-formaldehyde pre-condensate; and/or a substituted or un-substituted methacrylic acid-acrylic acid-acrylamide co-polymer cross-linked with a melamine-formaldehyde pre-condensate and/or a urea-formaldehyde pre-condensate and/or a substituted or un-substituted acrylic acid polymer cross-linked with a melamine-formaldehyde pre-condensate and/or a urea-formaldehyde pre-condensate.

Other applicable systems included capsules made via the simple or complex coacervation of gelatin, capsules having shell walls comprised of polyurethane, polyamide, polyolefin, polysaccaharide, protein, silicone, lipid, modified cellulose, gums, polyacrylate, polyphosphate, polystyrene, and polyesters or combinations of these materials are also functional.

Polymers systems are well know in the art and non-limiting examples of these include aminoplast capsules and encapsulated particles as disclosed in GB GB2006709 A; the production of micro-capsules having walls comprising styrene-maleic anhydride reacted with melamine-formaldehyde precondensates as disclosed in U.S. Pat. No. 4,396,670; capsules composed of cationic melamine-formaldehyde condensates as disclosed in U.S. Pat. No. 5,401,577; melamine formaldehyde microencapsulation as disclosed in U.S. Pat. No. 3,074,845; amido-aldehyde resin in-situ polymerized capsules disclosed in EP 0 158 449 A1; etherified urea-formaldehyde polymer as disclosed in U.S. Pat. No. 5,204,185; melamine-formaldehyde microcapsules U.S. Pat. No. 4,525,520; cross linked oil-soluble melamine-formaldehyde precondensate U.S. Pat. No. 5,011,634; capsule wall material formed from a complex of cationic and anionic melamine-formaldehyde precondensates that are then cross linked as disclosed in U.S. Pat. No. 5,013,473; polymeric shells made from addition polymers such as condensation polymers, phenolic aldehydes, urea aldehydes or acrylic polymer as disclosed in U.S. Pat. No. 3,516,941; urea-formaldehyde capsules as disclosed in EP 0 443 428 A2; melamine-formaldehyde chemistry as disclosed in GB 2 062 570 A; capsules composed of polymer or copolymer of styrenesulfonic acid in acid of salt form, and capsules cross linked with melamine-formaldehyde as disclosed in U.S. Pat. No. 4,001,140.

Capsule walls composed of negatively-charged, carboxyl containing polyelectrolyte with urea and formaldehyde are disclosed in U.S. Pat. No. 4,406,816. Capsule walls containing melamine-formaldehyde cross linked polymer or copolymer which possesses sulfonic acid groups as disclosed in WO 02/074430 A1.

Capsule walls comprising urea-formaldehyde or melamine-formaldehyde polymer and a second polymer comprising a polymer or copolymer of one or more anhydrides, preferably ethylene/maleic anhydride polymer as disclosed in U.S. Pat. No. 4,100,103; capsule walls contains melamine-formaldehyde precondensates and a polymer containing carboxylic acid groups as disclosed in EP 1 393 706 A1; encapsulated shell having an inner and outer surface as disclose in PCT 92/13448. Capsule walls comprising etherified amino-based prepolymers such as urea-, melamine-, benzoguanamine-, and glycouril-formaldehyde resins are known in the art.

Isocyanate-based capsule wall technology are disclosed in PCT 2004/054362; EP 0 148149 (also discloses polyamids, polyesters, polysulfonamide and polycarbonate capsules) EP 0 017 409 B1; U.S. Pat. No. 4,417,916, U.S. Pat. No. 4,124,526, U.S. Pat. No. 5,583,090, U.S. Pat. No. 6,566,306, U.S. Pat. No. 6,730,635, PCT 90/08468, PCT WO 92/13450, U.S. Pat. No. 4,681,806, U.S. Pat. No. 4,285,720 and U.S. Pat. No. 6,340,653.

Other suitable cross linking/chemistries are disclosed in U.S. Pat. No. 6,500,447; capsule walls containing free carboxyl groups having a polyamide, polyester structures and cross linked structures as disclosed in U.S. Pat. No. 4,946,624; wall material composed of materials that form microcapsules by coacervation techniques, preferably gelatin, and the cross linked preferably by glutaraldehyde U.S. Pat. No. 6,194,375 B1.

Other encapsulation systems include perfume materials absorbed in organic microparticles which have poly vinyl alcohol at their exterior. The particles are comprised of vinyl copolymers, styrenenic polymers, acrylic polymers and mixtures thereof, and cross linked versions thereof as disclosed in U.S. Pat. No. 3,726,803. A method to treat existing liquid-permeated capsule walls, wherein one component of a capsule wall treatment system comprising at least two components is held within the capsule wall material permeation pathways by being chemically complexed or otherwise bound therein as disclosed in PCT 03/020864.

Capsules having a continuous phase based on a mixture of an oil with a thermoplastic polymer and a discontinuous phase which is itself, and/or contains, a benefit agent and/or a colorant as disclosed in U.S. Pat. No. 6,740,631 B2.

An encapsulation process for multi-component controlled delivery systems for fabric care products are disclosed in U.S. Pat. No. 4,448,929. Wall comprising graft copolymer of polyvinyl alcohol and methyl vinyl ether/maleic acid as disclosed in U.S. Pat. Nos. 5,846,554 and 4,448,929.

Fragrance materials are often employed in products that also include high surfactant levels such as, but not limited to detergents, fabric softeners, rinse conditioners, dishwashing materials, scrubbing compositions, window cleaners, personal care cleaning products such as shampoos, body washes, and the like.

In these preparations, the fragrance materials can be used alone or in combination with other perfuming compositions, solvents, adjuvants and the like. The nature and variety of the other ingredients that can also be employed are known to those with skill in the art.

Many types of fragrances can be employed in the present invention, the only limitation being the compatibility with the other components being employed. Suitable fragrances include but are not limited to fruits such as almond, apple, cherry, grape, pear, pineapple, orange, strawberry, raspberry; and musk and flower scents such as lavender-like, rose-like, iris-like, and carnation-like. Other pleasant scents include herbal and woodland scents derived from pine, spruce and other forest smells. Fragrances may also be derived from various oils, such as essential oils, or from plant materials such as peppermint, spearmint and the like.

A list of suitable fragrances is provided in U.S. Pat. No. 4,534,891, the contents of which are incorporated by reference as if set forth in its entirety. Another source of suitable fragrances is found in Perfumes, Cosmetics and Soaps, Second Edition, edited by W. A. Poucher, 1959. Among the fragrances provided in this treatise are acacia, cassie, chypre, cyclamen, fern, gardenia, hawthorn, heliotrope, honeysuckle, hyacinth, jasmine, lilac, lily, magnolia, mimosa, narcissus, freshly-cut hay, orange blossom, orchid, reseda, sweet pea, trefle, tuberose, vanilla, violet, wallflower, and the like.

The following Table I sets forth publications which disclose fabric care, hair care and skin care applications containing high surfactant loadings in which encapsulated fragrance materials are advantageously employed:

TABLE I

| Procedure Type | U.S. Pat. No. |
|---|---|
| fabric care | 4,318,818 |
| fabric care | 5,916,862 |
| skin care | 6,514,487 |
| hair care | 6,544,535 |
| hair care | 6,540,989 |
| skin care | 6,514,489 |
| skin care | 6,514,504 |
| skin care and hair care | 6,514,918 |
| hard surfaces | 6,514,923 |
| fabric care | 6,524,494 |
| hair care | 6,528,046 |
| skin and hair care | 6,531,113 |
| skin care | 6,551,604 |
| carpet care | 6,531,437 |

The type of surfactant used in the present invention is not critical in carrying out the present invention. Suitable surfactant agents for use in the present invention include those surfactants that are commonly used in consumer products such as laundry detergents, fabric softeners and the like. The products commonly include cationic surfactants which also are used as fabric softeners; as well as nonionic and anionic surfactants.

Nonionic synthetic detergents are disclosed in U.S. Pat. No. 4,557,853, comprise a class of compounds which may be broadly defined as compounds produced by the condensation of alkylene oxide groups, hydrophilic in nature, with an organic hydrophobic compound, which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements.

For example, a well-known class of nonionic synthetic detergents is made available on the market under the trade name of “Pluronic.” These compounds are formed by condensing ethylene oxide with a hydrophobic base formed by the condensation of propylene oxide with propylene glycol. The hydrophobic portion of the molecule which, of course, exhibits water-insolubility has a molecular weight of from about 1500 to 1800. The addition of polyoxyethylene radicals to this hydrophobic portion tends to increase the water-solubility of the molecule as a whole and the liquid character of the products is retained up to the point where polyoxyethylene content is about 50% of the total weight of the condensation product.

Other suitable nonionic synthetic detergents include:

(i) The polyethylene oxide condensates of alkyl phenols, e.g., the condensation products of alkyl phenols having an alkyl group containing from about 6 to 12 carbon atoms in either a straight chain or branched chain configuration, with ethylene oxide, the said ethylene oxide being present in amounts equal to 10 to 50 moles of ethylene oxide per mole of alkyl phenol. The alkyl substituent in such compounds may be derived from polymerized propylene, diisobutylene, octane, and nonane, for example.

(ii) Those derived from the condensation of ethylene oxide with the product resulting from the reaction of propylene oxide and ethylene diamine—products which may be varied in composition depending upon the balance between the hydrophobic and hydrophilic elements which is desired. Examples are compounds containing from about 40% to about 80% polyoxyethylene by weight and having a molecular weight of from about 5000 to about 11,000 resulting from the reaction of ethylene oxide groups with a hydrophobic base constituted of the reaction product of ethylene diamine and excess propylene oxide, said base having a molecular weight of the order of 2500 to 3000, are satisfactory.

(iii) The condensation product of aliphatic alcohols having from 8 to 18 carbon atoms, in either straight chain or branched chain configuration, with ethylene oxide, e.g., a coconut alcohol ethylene oxide condensate having from 10 to 50 moles of ethylene oxide per mole of coconut alcohol, the coconut alcohol fraction having from 10 to 14 carbon atoms.

(iv) Trialkyl amine oxides and trialkyl phosphine oxides wherein one alkyl group ranges from 10 to 18 carbon atoms and two alkyl groups range from 1 to 3 carbon atoms; the alkyl groups can contain hydroxy substituents; specific examples are dodecyl di(2-hydroxyethyl)amine oxide and tetradecyl dimethyl phosphine oxide.

Useful nonionic surfactants in the present invention are disclosed in U.S. Pat. No. 5,173,200 and include the condensation products of ethylene oxide with a hydrophobic polyoxyalkylene base formed by the condensation of propylene oxide with propylene glycol. The hydrophobic portion of these compounds has a molecular weight sufficiently high so as to render it water-insoluble. The addition of polyoxyethylene moieties to this hydrophobic portion increases the water-solubility of the molecule as a whole, and the liquid character of the product is retained up to the point where the polyoxyethylene content is about 50% of the total weight of the condensation product. Examples of compounds of this type include certain of the commercially-available Pluronic™ surfactants (BASF Wyandotte Corp.), especial those in which the polyoxypropylene ether has a molecular weight of about 1500-3000 and the polyoxyethylene contact is about 35-55% of the molecule by weight, i.e., Pluronic™ L-62.

Useful nonionic surfactants include the condensation products of C8-C22 alkyl alcohols with 2-50 moles of ethylene oxide per mole of alcohol. Examples of compounds of this type include the condensation products of C11-C15 fatty alcohols with 3-50 moles of ethylene oxide per mole of alcohol which are commercially available from Shell Chemical Co., Houston, Tex., as, i.e., Neodol™ 23-6.5 (C12-C13 fatty alcohol condensed with about 7 moles of ethylene oxide), the PolyTergent™ SLF series from Olin Chemicals or the Tergitol™ series from Union Carbide, i.e., Tergitol™ S-15, which is formed by condensing about 15 moles of ethylene oxide with a C11-C15 secondary alkanol; Tergitol™ N-6, which is the condensation product of about 6 moles of ethylene oxide with isolauryl alcohol (CTFA name: isolaureth-6), Incropol™ CS-12, which is a mixture of stearyl and cetyl alcohol condensed with about 12 moles of ethylene oxide (Croda, Inc.) and Incropol™ L-7, which is lauryl alcohol condensed with about 7 moles of ethylene oxide (Croda, Inc.).

Useful nonionic surfactants also include C8-C24 fatty acid amides such as the monoamides of a mixture of arachidic and behenic acid (Kenamide™ B, Humko Chem. Co., Memphis, Tenn.), and the mono- or di-alkanolamides of (C8-C22) fatty acids, such as the diethanol amide, monoethanol amide or monoisopropanolamide of coconut, lauric, myristic or stearic acid, or mixtures thereof. For example, Monamide™ S is the monoethanol amide of stearic acid (Mona Industries, Inc., Paterson, N.J.) and Monamide™ MEA is the monoethanol amide of coconut acid (Mona).

Other nonionic surfactants which may be employed include the ethylene oxide esters of (C6-C12)alkyl phenols such as (nonylphenoxy)polyoxyethylene ether. Particularly useful are the esters prepared by condensing about 8-12 moles of ethylene oxide with nonylphenol, such as the Igepal™. CO series (GAF Corp., New York, N.Y.).

Other useful nonionics include the ethylene oxide esters of alkyl mercaptans such as dodecyl mercaptan polyoxyethylene thioether, the ethylene oxide esters of fatty acids such as the lauric ester of polyethylene glycol, i.e., PEG 600 monostearate (Akzo Chemie) and the lauric ester of methoxypolyethylene glycol; the ethylene oxide ethers of fatty acid amides, the condensation products of ethylene oxide with partial fatty acid esters of sorbitol such as the lauric ester of sorbitan polyethylene glycol ether, and other similar materials, wherein the mole ratio of ethylene oxide to the acid, phenol, amide or alcohol is about 5-50:1.

U.S. Pat. No. 4,557,853 discloses suitable anionic surfactants suitable for use in the present invention. The most common type of anionic synthetic detergents can be broadly described as the water-soluble salts, particularly the alkali metal salts, of organic sulfuric reaction products having in the molecular structure an alkyl radical containing from about 8 to about 22 carbon atoms and a radical selected from the group consisting of sulfonic acid and sulfuric acid ester radicals. Important examples of these synthetic detergents are the sodium, ammonium or potassium alkyl sulfates, especially those obtained by sulfating the higher alcohols produced by reducing the glycerides of tallow or coconut oil; sodium or potassium alkyl benzene sulfonates, in which the alkyl group contains from about 9 to about 15 carbon atoms, especially those of the types described in U.S. Pat. Nos. 2,220,099 and 2,477,383, incorporated herein by reference; sodium alkyl glyceryl ether sulfonates, especially those ethers of the higher alcohols derived from tallow and coconut oil; sodium coconut oil fatty acid monoglyceride sulfates and sulfonates; sodium or potassium salts of sulfuric acid esters of the reaction product of one mole of a higher fatty alcohol (e.g., tallow or coconut oil alcohols) and about three moles of ethylene oxide; sodium or potassium salts of alkyl phenol ethylene oxide ether sulfates with about four units of ethylene oxide per molecule and in which the alkyl radicals contain about 9 carbon atoms; the reaction product of fatty acids esterified with isethionic acid and neutralized with sodium hydroxide where, for example, the fatty acids are derived from coconut oil; sodium or potassium salts of fatty acid amide of a methyl taurine in which the fatty acids, for example, are derived from coconut oil; and others known in the art, a number being specifically set forth in U.S. Pat. Nos. 2,486,921, 2,486,922 and 2,396,278.

Another broad class of surfactants is cationic surfactants, and can be referred to as quaternary amine salts, or “quats.” These materials are described in U.S. Pat. No. 5,173,200, and also can function to condition the dried fabrics and to reduce static cling and lint adherence. The fabrics are softened in that their sheen, loft, and/or hand-feel is improved by either subjective or objective evaluation.

Subclasses of these materials are referred to by the art as monomethyl trialkyl quaternaries, imidazolinium quaternaries, dimethyl alkyl benzyl quaternaries, dialkyl dimethyl quaternaries, methyl dialkoxy alkyl quaternaries, diamido amine-based quaternaries and dialkyl methyl benzyl quaternaries wherein the “alkyl” moiety is preferably a (C8-C24)alkyl group and the quaternary (amine) is a chloride or methosulfate salt.

For convenience, one subclass of aliphatic quaternary amines may be structurally defined as follows:
(R)(R1)(R2)(R3)N+X—:

wherein R is benzyl, or lower(alkyl)benzyl; R1 is alkyl of 10 to 24, preferably 12 to 22 carbon atoms; R2 is C10-C.24-alkyl, C1-C.4-alkyl, or (C.2-C3)hydroxyalkyl, R3 is C1-C4-alkyl or (C2-C3)hydroxyalkyl and X represents an anion capable of imparting water solubility or dispersibility including chloride, bromide, iodide, sulfate and methosulfate. Particularly preferred species of these aliphatic quats include n-C12-C18-alkyl-dimethylbenzylammonium chloride (myrisalkonium chloride), n-C.12-C14-alkyldimethyl(ethylbenzyl)ammonium chloride (quaternium 14), dimethyl(benzyl)ammonium chloride, lauryl (trimethyl)ammonium chloride and mixtures thereof. These compounds are commercially available as the BTC series from Onyx Chemical Co., Jersey City, N.J. For example, BTC 2125M is a mixture of myrisalkonium chloride and quaternium-14. Dihydro-genated tallow methyl benzyl ammonium chloride is available as Variquat™ B-343 from Sherex Chem. Co., Dublin, and Ohio.

Other useful aliphatic quats include those wherein both R and R1 are (C8-C24)alkyl, such as the N,N-di-(higher)-C10-C.24-alkyl-N,N-di(lower)-C1-C4-alkyl-quaternary ammonium salts such as distearyl(dimethyl)ammonium chloride, dihydrogenated tallow(dimethyl)ammonium chloride, ditallow(dimethyl)ammonium chloride (Arquad™ 2HT-75, Akzo Chemie, McCook, Ill.), distearyl(dimethyl)ammonium methylsulfate and di-hydrogenated-tallow(dimethyl)ammonium methyl sulfate (Varisoft™ 137, Sherex).

Other useful quaternary ammonium antistatic agents include the acid salts of (higher(alkyl)-amido(lower)-alkyl)-dialkyl)-amines of the general formula:
[(A(C=0)-Y—)—N(R1)(R2)(R3)]+X—

wherein A is a C14-C24 normal or branched alkyl group, Y is ethylene, propylene or butylene, R1 and R2 are individually H, C.1-C.4 (lower)alkyl or (C1-C3)hydroxyalkyl or together form the moiety —CH2-CH2YCH2-CH2-, wherein Y is NH, O or CH2; R3 is the same as R1 or is also [A(C=0.0)Y—], and X is the salt of an organic acid. Compounds of this class are commercially available from Croda, Inc., New York, N.Y., as the Incromate™ series, e.g. Incromate™ IDL [isostearamidopropyl(dimethyl)amine lactate], Incromate™ISML [isostearamidopropy(morpholinium)lactate] and Incromate™ CDP [cocamidopropyl(dimethyl)amine propionate]. Ditallowdiamido methosulfate (quaternium 53) is available from Croda as Incrosoft™ T-75.

Preferred imidazolinium salts include: (methyl-1-tallow-amido)ethyl-2-tallow imidazolinium methyl sulfate; available commercially from Sherex Chemical Co. as Varisoft™ 475; (methyl-1-oleylamido)ethyl-2-oleyl imidazolinium methyl sulfate; available commercial from Sherex Chemical Co., as Varisoft™ 3690, tallow imidazolinium methosulfate (Incrosoft™ S-75, Croda) and alkylimidazolinium methosulfate (Incrosoft™ CFI-75, Croda).

Other useful amine salts are the stearyl amine salts that are soluble in water such as stearyl-dimethylamine hydrochloride, distearyl amine hydrochloride, decyl pyridinium bromide, the pyridinium chloride derivative of the acetylaminoethyl esters of lauric acid, decylamine acetate and bis-[(oleoyl)-(5,8)-ethanoloxy]-tallow(C14-C18)aminehydrogen phosphate (Necon™ CPS-100) and the like.

Those with skill in the art appreciate that certain surfactants are employed as food grade products. Surfactants include those described in U.S. Pat. No. 6,770,264 include those selected from the group consisting of anionic high-foam surfactants, such as linear sodium C12-18 alkyl sulfates; sodium salts of C.12-16 linear alkyl polyglycol ether sulfates containing from 2 to 6 glycol ether groups in the molecule; alkyl-(C.12-16)-benzene sulfonates; linear alkane-(C12-18)-sulfonates; sulfosuccinic acid mono-alkyl-(C.12-18)-esters; sulfated fatty acid monoglycerides; sulfated fatty acid alkanolamides; sulfoacetic acid alkyl-(C.12-18)-esters; and acyl sarcosides, acyl taurides and acyl isothionates all containing from 8 to 18 carbon atoms in the acyl moiety. Nonionic surfactants, such as ethoxylates of fatty acid mono- and diglycerides, fatty acid sorbitan esters and ethylene oxide-propylene oxide block polymers are also suitable. Particularly preferred surfactants are sodium lauryl sulfate and sacrosinate. Combinations of surfactants can be used.

Additional surfactant materials are described in U.S. Pat. No. 6,361,761 and include taurate surfactants The term “taurate surfactant” as used in the present specification is a surfactant which is a N-acyl N-alkyl taurate alkali metal salt. A preferred taurate surfactant is available from Finetex Inc., as Tauranol™ WHSP.

Representative taurate surfactants include the sodium, magnesium and potassium salts of N-cocoyl-N-methyltaurate, N-palmitoyl-N-methyl-taurate and N-oleyl-N-methyl taurate and their lauroyl, myristoyl, stearoyl, ethyl, n-propyl and n-butyl homologs.

In U.S. Pat. No. 6,696,044, sodium stearate is described as preferred surfactants for use in chewing gum compositions. Sodium stearate is usually available as an approximate 50/50 mixture with sodium palmitate, and, a mixture of at least one citric acid ester of mono and/or diglycerides. A suitable example of a commercial stain removing agent in the latter class is IMWITOR 370.™ sold by Condea Vista Company. A further preferred surfactant is a mixture of lactic acid esters of monoglycerides and diglycerides.

U.S. Pat. No. 6,616,915 describe a broad class of surfactants suitable for use in oral hygiene. Typical examples of anionic surfactants are soaps, alkylbenzene sulphonates, alkane sulphonates, olefine sulphonates, alkylether sulphonates, glycerolether sulphonates, .alpha.-methylester sulphonates, sulphofatty acids, alkyl sulphates, fatty alcohol ether sulphates, glycerol ether sulphates, mixed hydroxy ether sulphates, monoglyceride (ether)sulphates, fatty acid amide (ether)sulphates, mono- and dialkyl sulphosuccinates, mono- and dialkyl sulfosuccinamates, sulpho triglycerides, amido soaps, ether carboxylic acids and their salts, fatty acid isethionates, fatty acid sarcosinates, fatty acid taurides, N-acylamino acids such as for example acyl lactylate, acyl tartrate, acyl glutamate and acyl aspartate, alkyl oligoglucoside sulphate, protein fatty acid condensate (especially plant products based on wheat) and alkyl (ether) phosphate. If the anionic surfactants contain polyglycol ether chains, these could show a conventional, but preferably a narrow homologue distribution. Typical examples of nonionic surfactants are fatty alcohol polyglycol ethers, alkylphenol polyglycol ethers, fatty acid polyglycol esters, fatty acid amide polyglycol ethers, fatty amino polyglycol ethers, alkoxylated triglycerides, mixed ethers, respectively mixed formals, possibly partially oxididized alk(en)yl oligoglycosides, respectively glucoronic acid derivatives, fatty acid-N-alkylglucamides, protein hydrolysates (especially plant products based on wheat), polyol fatty acid esters, sugar esters, sorbitan esters, polysorbates and amine oxides. Provided that the nonionic surfactants contain polyglycolether chains, these can show a conventional, but preferably a narrow distribution of homologues. Based on application technology reasons—especially compatibility with the oral mucosa and foaming ability the use of alkyl sulphates, alkyl ether sulphates, monoglyceride (ether)sulphates, oleflne sulphonates and alkyl and/or alkenyl oligoglycosides as well as their mixtures is preferable, and they can be used as water containing pastes, preferably, however, as water free powders or granulates, which can be obtained for example by the Flash-Dryer or by the SKET procedure.

Encapsulation production processes useful for producing polymer particles useful in the practice of our invention are set forth in the references listed in the following Table II:

TABLE II

| Polymer Particle Production Type | U.S. Pat. No. |
|---|---|
| ethylene-vinyl acetate copolymers | U.S. Pat. No. 4,521,541 |
| ethyl cellulose | U.S. Pat. No. 6,509,034 |
| Polystyrene | U.S. Pat. No. 4,247,498 |
| polymethyl methacrylate | U.S. Pat. No. 4,247,498 |

Other particle production processes useful for producing polymer particles useful in the practice of our invention are set forth in U.S. Pat. Nos. 3,505,432; 4,731,243; 4,934,609 and 6,213,409.

The present invention can also be adapted by those skilled in the art and applied to other widely used delivery systems or encapsulation media including, but not limiting to: emulsions, gels, cream, concentrated emulsion, gels, polymer emulsions such as those produced by emulsion polymerization and that containing either particles or capsules.

Because microencapsulation processes and products are widely used in pharmaceutical, agricultural, biotechnology, tropical delivery systems, and other controlled release applications, the dialysis and direct inject method can be used by those skilled in art for stability evaluation, formulation optimization, material screening and process controls.

Since fragrance molecules are invariably organic molecules and most active pharmaceutical ingredients (API) and agrochemical ingredients are also organic molecules, the dialysis and direct injection method can be easily adapted by those skilled in the art to investigate the release of any encapsulated organic molecules for specific applications.

Upon review of the foregoing, numerous adaptations, modifications, and alterations will occur to the reviewer. These will all be, however, within the spirit of the present invention. Accordingly, reference should be made to the appended claims in order to ascertain the true scope of the present invention. All US patent and published US patent applications cited herein are incorporated by reference as if set forth herein in their entirety. The following examples are provided to further illustrate the present invention and should not be considered limiting the present invention. In these examples, all percent points are meant to be percent by weight unless noted to the contrary.

### EXAMPLES

### Example One

In this example, a capsule slurry containing 35% fragrance oil was prepared according to the method discussed in US Patent Publications US 2004-0072719 and US 2004-0072710. The capsules have shell walls composed of an acrylamide-acrylic acid co-polymer cross-linked with melamine-formaldehyde resin. The fragrance accord was made up from four components including benzyl acetate, cyclacet, fenchyl acetate and Lilial. A model fabric softener solution was prepared and used in the experiment. The fabric softener contains approximately 24% surfactant solution. The dialysis cell used in the experiement was purchased from BelArt Corp, NJ.

The release of benzyl acetate into fabric softener solution was carried out using a testing solution containing 47 gram (g) of the surfactant solution and 3 g of the capsule slurry. The total concentration of benzyl acetate was 0.166% of the mixture. The dialysis cell was placed into a theromstated shaker at 37° C. under constant agitation. The experimental setup was as follows:

| | Half-cell A | Half-cell B |
|---|---|---|
| Surfactant solution | 5 ml | |
| Surfactant + 3% capsule | | 5 ml |

The amount of leached component found in Half-cell A was determined by injecting a small sample taken from A into GC. The release profile of benzyl acetate was obtained directly and tabulated below:

| Time (hrs) | Benzyl Acetate (ppm) |
|---|---|
| 6 | 132 |
| 24 | 348 |
| 47 | 592 |
| 168 | 888 |

Using the dialysis method of the present invention, the leaching of benzyl acetate was easily monitored and determined. Tedious extraction was unnecessary. Furthermore, direct injection will intrinsically give more reliable results when compared with extraction at lower analyte level, as there were few experimental steps involved.

### Example Two

This example illustrates the use of the dialysis and direct injection method in determining the passive release of encapsulated fragrance components. A capsule slurry containing 35% fragrance oil was prepared according to the method discussed in US Patent Publications US 2004-0072719 and US 2004-0072710. The capsules have shell walls composed of an acrylamide-acrylic acid co-polymer cross-linked with melamine-formaldehyde resin. The fragrance accord was made up from four components including benzyl acetate, cyclacet, fenchyl acetate and Lilial. The commercially available fabric softener, Downy® (Procter & Gamble), was purchased locally and used in the experiments. The dialysis cell used in the experiement was purchased from BelArt Corp. NJ. The dialysis cell was placed into a thermostated shaker at 37° C. under constant agitation.

The leaching of benzyl acetate and cyclacet were monitored by the dialysis and direct injection method using the following set-up. The fragrance leached out was measured by direct GC analysis. No extraction was necessary.

| | Half-cell A | Half-cell B |
|---|---|---|
| 25% Downy solution | 5 ml | |
| Capsule slurry | | 5 ml |

The amount of fragrance leached from the capsule was measured by direct GC injection.

| Time | Benzyl Acetate | Cyclacet |
|---|---|---|
| (hrs) | (ppm) | (ppm) |
| 5 | 383 | 34 |
| 24 | 1319 | 159 |
| 56 | 1816 | 194 |
| 144 | 2360 | 370 |

Employing the dialysis method, the passive release of fragrance component was measured easily with good temporal resolution. The dialysis method provided two unique functions. It allowed the application medium and the surfactant solution to be separated from capsule so that the passive release can be examined. The method also allowed the use of the surfactant solution to act as a sink to absorb the fragrance molecules, which leached out of the solution, as soon as they move across the membrane. Without the surfactants, the passive release process will quickly terminate once the concentration of the fragrance molecules leached out reached their aqueous solubility. Employed under this configuration, the dialysis can also enable the measurement of the absorbing capacity of a particular surfactant. This would not be possible without using the dialysis method. The above examples demonstrate the ease of measuring the level of fragrance leached over time from the capsules. This direct measurement of fragrance release by this method was accomplished in an easier and more direct method than previously employed.

### Example Three

This example illustrates use of the dialysis and direct injection method in determining the leaching of fragrance component from polymer matrix, specifically polymer particles. The polymer particles were prepared from commercially available ethylene-co-vinylactate polymer by Dupont. It was further sieved to have a physical dimension between 90 and 150 micrometers. A fragrance commercially available from the International Flavors & Fragrances Inc. was used in the experiment. Fragrance loading was accomplished by simple absorption process. The amount of fragrance loaded into the capsule was 20% by weight. A model fabric softener was prepared and used in the experiment. The fabric softener contains approximately 9% surfactant solution. The fragrance loaded particle was blended in the surfactant solution to give a concentration of 1% neat fragrance oil. The dialysis cell used in the experiment was purchased from BelArt Corp. NJ. The dialysis cell was placed into a thermostated shaker at 37° C. under constant agitation. The arrangement of cell was as follows:

| | Half-cell A | Half-cell B |
|---|---|---|
| Softener solution | 5 ml | |
| Particle/fragrance mixture | | 5 ml |

The dialysis cell was placed into a thermostat shaker at 37° C. under constant agitation for two weeks. At the end of two weeks, the solution from half cell A was diluted by 50% with water and injected into GC. The amount of total fragrance found was 0.026%. From this, it can be calculated that the amount of fragrance retained was 89.6%.

The example clearly demonstrates that the membrane can act as a barrier for polymer particle diffusion. It allows a rapid assessment of the release characteristic of fragrance from polymer matrix. Alternative indirect methods such as SPME and hexane extraction are more time consuming, less sensitive and less reliable as the amount of leaching is quite low and there is more intrinsic uncertainty in such indirect method.

It is clear that the dialysis method can easily be adapted by those skilled in the art to other polymer microencapsulation systems to asses the release of active materials.

### Example Four

This example illustrates the versatility and flexibility of the dialysis and direct injection method, which is accomplished using a multi-cavity cell. The multi-cavity cell was purchased from Bel-Art. A capsule slurry containing 35% fragrance component cyclacet was prepared according to the method discussed in US Patent Publications US 2004-0072719 and US 2004-0072710. The capsules have shell walls composed of an acrylamide-acrylic acid co-polymer cross-linked with melamine-formaldehyde resin. The commercial fabric softener, Downy®, was purchased locally and used in the experiment. Downy® is an aqueous solution containing about 25% surfactant. A multi-cavity dialysis cell with a total of 10 half cells was purchased from BelArt Corp. NJ and used in the experiment A total of six half cells were utilized in this experiments. Each of the half cell has a capacity of 1 millimeter. The experiment was configured in the following way:

| | Half cell | | |
|---|---|---|---|
| | A1 | A2 | A3 |
| Downy ® solution | 1 ml | 1 ml | 1 ml |
| | Half cell | | |
| | B1 | B2 | B3 |
| Downy ® solution with capsule | 1 ml | 1 ml | 1 ml |

The dialysis cell was placed into the thermostat oven at 40° C. with constant shaking for 12 hours. Samples were then taken out from B1, B2, and B3 and analyzed for the amount of cyclacet leached out. The amount of cyclacet found was 134, 688 and 643 ppm respectively.

Using the dialysis method with a multi-cavity cell, one can easily change the experimental conditions to obtain analytical results much sooner than with traditional extraction and SPME methods. This approach can be readily adapted by those skilled in the art for high throughout screening and formulation development.

### Example Five

This example illustrates the use of the dialysis and direct injection method to determine trans-membrane equilibration of fragrance molecules. A capsule slurry containing 35% commercial fragrance was prepared according to the method discussed in US Patent Publications US 2004-0072719 and US 2004-0072710. The capsules have shell walls composed of an acrylamide-acrylic acid co-polymer cross-linked with melamine-formaldehyde resin. Multi-cavity cells from BelArt Corp were employed for this experiment. A model fabric softener was prepared and used in the experiment. The fabric softener contains approximately 9% surfactant solution. The fragrance capsule was blended in the surfactant solution to give a concentration of 1% neat fragrance. The arrangement of cell was as follows:

| | Half cell | | | | |
|---|---|---|---|---|---|
| | A1 | A2 | A3 | A4 | A5 |
| Surfactant solution | 1 ml | 1 ml | 1 ml | 1 ml | 1 ml |
| | Half cell | | | | |
| | B1 | B2 | B3 | B4 | B5 |
| Surfactant solution with capsule | 1 ml | 1 ml | 1 ml | 1 ml | 1 ml |

The dialysis cell was placed into the thermostated oven at 37° C. with constant shaking. Samples were taken periodically from half-cell B and the increase in was determined. The movements of three fragrance components, cinnamic alcohol, methyl beta napthyl ketone, and terpineol were followed. These three fragrance chemicals were chosen because they have different chemical and physical properties to illustrate the versatility of the dialysis and direct injection method. The difference is measurable by their octanol to water partition coefficient, logP. The calculated logP (ClogP) is normally determined by the fragment approach on Hansch and Leo (A. Leo, in Comprehensive Medicinal Chemistry, Vol. 4, C. Hansch, P. G. Sammens, J. B. Taylor and C. A. Ransden, Editiors, p. 295 Pergamon Press, 1990). This approach is based upon the chemical structure of the fragrance ingredient and takes into account the numbers and types of atoms, the atom connectivity and chemical bonding. The ClogP values which are most reliable and widely used estimates for this physiochemical property can be used instead of the experimental LogP values useful in the present invention. Further information regarding ClogP and logP values can be found in U.S. Pat. No. 5,500,138.

The results are given in the following table.

| | Concentration of | Concentration of | Terpineol |
|---|---|---|---|
| | Cinnamic alcohol | Methyl beta napthyl | Coeur |
| | (ppm) | ketone (ppm) | (ppm) |
| Time (hours) | clogP = 1.45 | clogP = 2.0 | clogP = 2.75 |
| 24 | 73 | 72 | 188 |
| 120 | 112 | 167 | 471 |
| 168 | 118 | 203 | 483 |
| 336 | 119 | 250 | 490 |

It was found, after 2 weeks, all three components have reached their equilibrium concentrations, which were calculated using the starting concentrations. Application of the dialysis method made such measurement feasible. It also allowed one to measure the binding affinity of surfactant solutions for fragrance molecules. The method can be easily adapted by those skilled in the art to measure the permeability of molecules across different membrane materials.

### Example Six

This example illustrates the use of the dialysis method to determine the amount of core materials at equilibrium. A capsule slurry containing 35% fragrance was prepared according to the method discussed in US Patent Publications US 2004-0072719 and US 2004-0072710. The fragrance was a commercially available fragrance from International Flavors and Fragrance. The capsules have shell walls composed of an acrylamide-acrylic acid co-polymer cross-linked with melamine-formaldehyde resin. A dialysis cell from BelArt Corp was employed for this experiment. A model fabric softener solution was prepared and used in the experiment. The fabric softener contains approximately 9% surfactant solution. The fragrance was blended in the surfactant solution to give a concentration of 1% neat fragrance. The arrangement of cell was as follows:

| | Half-cell A | Half-cell B |
|---|---|---|
| Softener solution | 5 cc | |
| Softener/capsule mixture | | 5cc |

The dialysis cell was placed into the thermostated oven at 37° C. with constant agitation. The amount of fragrance component leached out was monitored as a function of time. After two weeks, it was found that at 37° C. there was no further change in the amount of free fragrance, as determined by GC. The amount of fragrance molecules retained at equilibrium was calculated. The results are given in the following table.

| Fragrance | | Fragrance retention in |
|---|---|---|
| ingredient | ClogP | core (%) |
| Cinnamic alcohol | 1.45 | 25 |
| Methyl beta | 2.0 | 54 |
| napthyl ketone | | |
| Terpineol Coeur | 2.75 | 75 |

It is found that the leaching rate of fragrance component decreased as the clogP of the component increased. As a result, the amount of fragrance retained in the core increased.

Using the dialysis and direct injection method, one can quickly assess the leaching rates of the encapsulated active ingredient. It can be readily adapted by those skilled in the art as a quantitative tool for the high throughout screening of capsules materials and active ingredients.

### Example Seven

This example illustrates the use of the filtration and direct injection method in determining the passive release of encapsulated fragrance components. Two capsule slurry (Product 1 and Product 2) containing 17.5% commercial fragrance oil were prepared according to the method discussed in US Patent Publications US 2004-0072719 and US 2004-0072710. The capsules have shell walls composed of an acrylamide-acrylic acid co-polymer cross-linked with melamine-formaldehyde resin. A model fabric softener was prepared and used in the experiment. The fabric softener contains approximately 9% surfactant solution. Fragrance capsule slurry was individually blended in the surfactant solution to give a concentration of 1% neat fragrance, and each mixture solution was placed into an oven at 45° C. Samples were taken periodically from the mixture solution and transferred into a Whatman syringe filter with a 1.0 um pore size. The amount of fragrance leached out from capsules was measured by direct GC injection of filtrate from filtration.

The results are given in the following table.

| Time | Fragrance concentration | Fragrance concentration |
|---|---|---|
| (hours) | (ppm) of Product 1 in filtrate | (ppm) of Product 2 in filtrate |
| 1 | 215 | 411 |
| 24 | 659 | 710 |
| 96 | 1242 | 1526 |
| 168 | 1604 | 2050 |
| 264 | 1257 | 2891 |
| 360 | 2103 | 4496 |

It was found that, within 15 days, the fragrance release from capsules was easily monitored by the direct injection of the filtrate into GC. The filtration method also appears to possess sufficient sensitivity to differentiate release rate differences between the two capsule products. A similar fragrance release pattern was observed between these two products under the same storage condition using the dialysis method described in Example one, which further demonstrates the utility and validity of the filtration method.

We claim:

1. A method for measurement of the amount and the release rate of encapsulated material in application medium comprising:
providing a container;
providing a semi-permeable membrane within said container, thereby dividing said container into a first and second part, said membrane being permeable to encapsulated active ingredient, but not permeable to capsules;
providing a solution of application medium in the first part of the container;
providing a solution mixture of application medium and encapsulated active ingredient in the second part of the container;
allowing the first and the second part to be held together for at least one hour;
measuring the concentration of the active ingredient in the first part of the container.

2. A method for measurement of the amount and the release rate of encapsulated material in application medium comprising:
providing a filtration apparatus;
Providing a filter;
providing a solution mixture of application medium and encapsulated active ingredient which was stored in the oven for the desired period of time
filtering the solution mixture through the selected filter;
measuring the concentration of the active ingredient in the filtrate.

3. A method for measurement of the absorption and binding of active ingredient by application medium comprising:
providing a container;
providing a semi-permeable membrane within said container, thereby dividing said container into a first and second part, said membrane being permeable to the active ingredient, but not permeable to application medium;
providing a solution of application medium in the first part of the container;
providing a solution mixture of a different application medium and active ingredient in the second part of the container;
allowing the first and the second part to be held together for at least one hour;
measuring the concentration of the active ingredient in the first part of the container.

4. A method for measurement of the rate equilibration and translocation of active ingredient across membrane comprising:
providing a container;
providing a semi-permeable membrane within said container, thereby dividing said container into a first and second part, said membrane being permeable to the active ingredient;
providing a solution of application medium in the first part of the container;
providing a solution mixture of the same application medium and active ingredient in the second part of the container;
allowing the first and the second part to be held together for at least one hour;
measuring the concentration of the active ingredient in the first part of the container.

5. A method as in any one of claims 1, 2, 3 or 4 wherein the active material is selected from the group comprising of flavor, fragrance, agrochemical and pharmaceutical molecules.

6. A method as in any one of claims 1, 2, 3 or 4, wherein the active material is directly injected into a gas chromatograph or High Performance Liquid Chromatograph or other suitable analytical instruments.

7. A method as in any one of claims 1, 2, 3 or 4, wherein the membrane or filter is made from material selected from the group comprising of cellulose acetate, cellulose nitrate, mixed cellulose esters, polyvinylidene difluoride, polysulfone, polyamide, nylon, polycarbonate, polytetrafluoroethylene, polypropylene, glass microfiber and sulfonated polyethersulfone.

8. A method as in any one of claims 1, 2, 3 or 4, wherein the concentration of the active ingredient is measured by either gas chromatograph or high performance liquid chromatography or other suitable analytical methods.

9. A method as in any one of claims 1, 2, 3 or 4 wherein the application medium solution is a surfactant solution.

10. A method as in claim 1 or 2, wherein the encapsulation medium is selected from the group comprising of capsules, particles, emulsions and gels.

11. A method as in claim 1 or 2 wherein the solution mixture of the application medium and encapsulated active ingredient is stored for at least an hour.

12. A method as in claim 1 or 2, wherein the solution mixture of the application medium and encapsulated active ingredient is used upon preparation of said solution mixture.

13. A method as in any one of claims 1, 3, or 4, wherein the membrane is capable of retaining materials of molecular weight of at least 6000 grams per mole.

14. A method for measurement of release rate of encapsulated material as in claim 9, wherein the surfactant solution is selected from the group comprising of detergent, fabric softener, shampoo, lotion, liquid body wash, liquid dish wash, and tooth paste.

15. A method for measurement of release rate of encapsulated material as in claim 9, wherein the concentration of the surfactant is in the range of from about 1% to about 50% by weight of the solution.

16. A method for measurement of release rate of encapsulated material as in claim 9, wherein the concentration of the surfactant is in the range of from about 5% to about 35% by weight of the solution.

17. A method for measurement of release rate of encapsulated material as in claim 9, wherein the concentration of the surfactant is in the range of from about 8% to about 30% by weight of the solution.

18. A method for measurement of release rate of encapsulated material as in claim 2, wherein the pore size of the membrane is from 0.2 μm to 10 μm.

19. A method for measurement of release rate of encapsulated material as in claim 2, wherein the pore size of the membrane is from 0.45 μm to 2 μm.

20. A method for measurement of release rate of encapsulated material as in claim 2, wherein the filter material is made from glass fiber.
